(19) United States
(12) Patent Application Publication
(10) Pub. No.: US 2015/0237679 A1
(43) Pub. Date: Aug. 20, 2015

(54) Mineral Insulated Skin Effect Heating Cable

(71) Applicant: Pentair Thermal Management LLC, Menlo Park, CA (US)

(72) Inventors: David G. Parman, San Ramon, CA (US); Lawrence White, Newark, CA (US)

(21) Appl. No.: 14/696,191

(22) Filed: Apr. 24, 2015

Related U.S. Application Data
(63) Continuation of application No. 13/262,374, filed on Sep. 30, 2011.

(51) Int. Cl. H05B 3/56

(52) U.S. Cl. CPC H05B 3/56

(57) ABSTRACT

A skin-effect heater cable has inorganic ceramic insulation. The heater cable has at lease one core conductor wire within a sheath. Electricity is directed through the core conductor in an outward path and returns along a surface “skin” of the sheath in a return path for generating heat.

### FIELD OF INVENTION

The present invention generally relates to electrical heating cables, and more particularly to skin-effect heater cables having inorganic ceramic insulation that utilizes at least one core conductor wire within a sheath whereby electricity is directed through the core conductor in an outward path and returns along a surface “skin” of the sheath in a return path for generating heat.

### SUMMARY OF THE INVENTION

The present invention includes a heater device having a skin effect component with at least one insulated electrical core conductor in electrical communication with an adjacent and substantially parallel, elongated ferromagnetic shape having a reduction and localization of the depth and width of the effective conductor path in the cross-section of the ferromagnetic wall and an inorganic ceramic insulation component. Preferably the inorganic ceramic insulation component contains magnesium oxide.

The present invention also includes a heating process, comprising the steps of providing a heater device comprising a skin effect component having at least one insulated electrical core conductor in electrical communication with an adjacent and substantially parallel, elongated ferromagnetic shape having a reduction and localization of the depth and width of the effective conductor path in the cross-section of the ferromagnetic wall and an inorganic ceramic insulation component and applying electrical current through the electrical core thereby heating the ferromagnetic shape.

It is an objective of the instant invention to provide a mineral insulated, skin-effect heater.

Still yet another objective of the instant invention is to provide a mineral insulated, skin-effect heater adapted to oil field applications.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 illustrates a perspective view, partially in section, illustrating one embodiment of the instant invention;

FIG. 2 illustrates a perspective view, partially in section, illustrating one embodiment of the instant invention.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

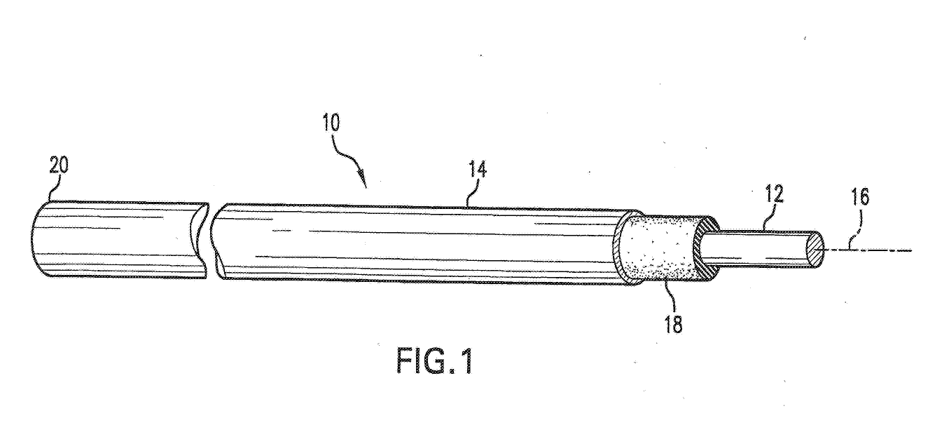

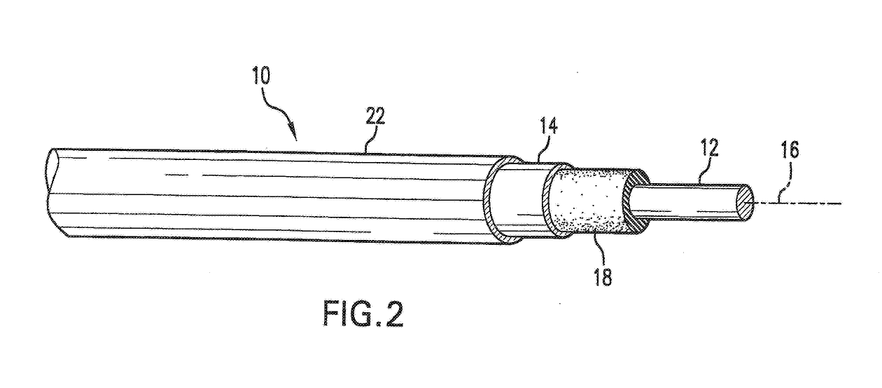

Referring generally to FIGS. 1 and 2, a preferred embodiment of a mineral insulated, skin-effect heater of the present invention is illustrated. The mineral insulated, skin effect heater 10 may include an inner core conductor 12 inside an outer conductor 14. The inner conductor and the outer conductor may be radially disposed about a central axis 16. The inner and outer conductors may be separated by an insulation layer 18. In certain embodiments, the inner and outer conductors may be coupled at a distal end 20 of the heater. Electrical current may flow into the heater 10 through the inner conductor 12 and return through the outer conductor 14 or visa-versa. One or both conductors 12, 14 may include ferromagnetic material.

In one embodiment, the mineral insulated, skin-effect heater 10 is provided with an inner ferromagnetic conductor 12 and an outer ferromagnetic conductor 14, the skin-effect current path occurs on the outside of the inner conductor and on the inside of the outer conductor. Thus, the outside of the outer conductor may be clad with a layer of corrosion resistant alloy 22, such as stainless steel, without affecting the skin-effect current path on the inside of the outer conductor.

The insulation layer 18 may comprise an electrically insulating ceramic with high thermal conductivity, such as magnesium oxide, aluminum oxide, silicon dioxide, beryllium oxide, boron nitride, silicon nitride, etc. Of these, magnesium oxide is most preferred. The insulating layer may be a compacted powder (e.g., compacted ceramic powder). Compaction may improve thermal conductivity and provide better insulation resistance and in a most preferred, non-limiting embodiment, the compaction is about 80%. It should also be noted that other compaction rates can be utilized without departing from the scope of the invention.

Generally, the insulated electrical core conductor carries alternating current (AC) out in one leg of a circuit so that the AC flows back through an adjacent and substantially parallel, elongated ferromagnetic shape to Provide the return leg of the circuit. A skin effect in the localized surface of the ferromagnetic shape or conductor which is in a band immediately adjacent to the core, is developed by induction and magnetic effects and causes a heating effect.

In “skin-effect” heating, heat is generated in the ferromagnetic envelope wall by the I˜R loss of return current flow and by hysteresis and eddy currents induced by the alternating magnetic field around the insulated conductor.

The electromagnetic interaction between the current in the insulated core conductor and the return current in the envelope causes the current to concentrate at its inner surface due to skin effect; hence, the name skin-effect heating cable. The strength of this phenomenon is increased by being in close proximity to the core conductor (referred to as proximity effect).

The proximity relation of the two conductors causing the current to flow out and back and proper electromagnetic shielding further increases these effects, the basis of the Present advantageous system. Alternating current flows only along a band of the skin of the elongated piece of ferromagnetic material acting as a very specialized conductor under these conditions.

As a non-limiting example, a ferromagnetic pipe may be considered which has a minimum wall thickness of about three times the skin depth, or about ⅛ inch, more or less for various ferromagnetic materials and AC frequency. AC may be conducted out to the far end of the pipe by an adjacent, internal, and insulated wire which is connected to the inner wall of the distal end of the pipe. Due to what is called the “skin-effect”, a substantial portion of the AC flows back on that part of the inside surface or skin of the pipe which is immediately adjacent and parallel to the conductor wire. This band of the steel surface subtended from the wire becomes what may be called a skin-effect conductor/resistor. The balance of the surface of the pipe is for practical purposes, effectively insulated electrically from any object contacting it. This considerable reduction of what is normally regarded as the effective cross-section of an electrical conductor (the entire pipe), greatly increased the effective resistance of what otherwise would be entirely a conductor. The outer pipe wall is also in effect non-conductive, and the pipe may be grounded and even touched without shock.

It should be appreciated that movement of the wire in relation to the ferromagnetic material may change the proximity effect, the Pipe's resistance, and the heat generated. Therefore, an off-setter or a centralizer may be utilized to position the core conductor with respect to the ferromagnetic return leg of the circuit. The off-setter or centralizer may also provide insulating properties to the core conductor to allow higher currents to be passed through the circuit without arcing between the core conductor and the return leg. Inert gasses may be used in conjunction with, ceramic type insulators to provide additional insulating properties.

Heater materials may be selected to enhance physical properties of a heater. For example, heater materials may be selected such that inner layers expand to a greater degree than outer layers with increasing temperature, resulting in a tight-packed structure. An outer layer of a heater may be corrosion resistant. Structural support may be provided by selecting outer layer material with high creep strength or by selecting a thick-walled conduit. Various impermeable layers may be included to inhibit metal migration through the heater.

While the ferromagnetic shape often may be a pipe and the utilitarian fluid may be a liquid being forced therethrough, in other cases, the steel shape may be other than tubular—e.g., planer, conical, spheroidal, etc.; and the utilitarian fluid may be heated by being passed or forced into contact therewith, rather than transported thereby.

The mineral insulated, skin-effect heaters of the instant invention may be applied to a wide range of applications, including but not limited to, snow and ice melting, pipeline heat tracing (onshore and subsea), and oil field applications including downhole wellbore heating, bottom hole heating, horizontal wellbore heating and reservoir stimulation.

Some embodiments of heaters may include switches (eg., fuses and/or thermostats and/or thermisters and/or thyristors) that turn off or reduce power to a heater or portions of a heater when a certain condition is reached in the heater. In certain embodiments, a skin-effect heater may be used to provide heat to a hydrocarbon containing formation. In one embodiment, control and monitoring of the skin-effect heater cable is accomplished with a closed loop feedback control comprising temperature controllers and contactors. In another embodiment, fiber optic temperature measurement may be utilized. Such systems could be linked into the control of a skin-effect heater using algorithms to provide between one and several hundred temperature sensing points along a heater circuit. In some embodiments, the fiber optic cables and/or sensors could be incorporated within the heater cable. In another embodiment, pressure sensors could be utilized to regulate heat output based on pressure provided by the heaters surroundings.

In some embodiments, AC frequency may be adjusted to change the skin depth of a ferromagnetic material. For example, the skin depth of to carbon steel at room temperature is about 0.11 cm at 60 Hz, about 0.07 cm at 180 Hz, and about 0.04 cm at 440 Hz. Since thickness of the outer ferromagnetic conductor is typically three times the skin depth, using a higher frequency may result in a smaller heater and may reduce equipment costs. Frequencies between about 50 Hz and about 1000 Hz may be used.

In some embodiments, electrical current may be adjusted to achieve an optimal skin depth of a ferromagnetic material. A smaller skin depth may allow a heater with smaller dimensions to be used, thereby reducing equipment costs. In certain embodiments, the applied current may range from at least about 10 amps up to 500 amps, or greater. In some embodiments, alternating current may be supplied at voltages up to or above about 2500 volts.

Again referring to FIGS. 1 and 2, in certain embodiments described herein, mineral insulated, skin-effect heaters are dimensioned to operate at a frequency of about 60 Hz. It is to be understood that dimensions of a skin-effect heater may be adjusted from those described herein in order for the skin-effect heater to operate in a similar manner at other frequencies.

The mineral insulated, skin-effect heater of the present invention has very high power output capability compared to existing forms of electric heating cables, allowing a single heater to provide sufficient power for high flow rate applications. The heater generally provides a rugged structure, such as in those embodiments incorporating a heavy steel wall outer layers. In another embodiment, the mineral insulated, skin-effect heater, when manufactured in a rod form, may be deployed using existing coiled tube equipment, reducing installation costs. With use under a coiled tube deployment, the mineral insulated, skin-effect heater can be readily installed inside an oil or gas pipe, thereby maximizing heat transfer from the heater into the fluid. As a skin effect heater, a single cable can readily provide a complete electrical heating circuit whereas 2 or 3 cables of other styles may be required to form a complete circuit.

In certain embodiments, ferromagnetic materials may be coupled with other materials (e.g., non-ferromagnetic materials and/or highly conductive materials such as copper) to provide various electrical and/or mechanical properties. Some Parts of a skin-effect heater may have a lower resistance (caused by different geometries and/or by using different ferromagnetic and/or non-ferromagnetic materials) than other parts of the skin-effect heater. Having parts of a skin-effect heater with various materials and/or dimensions may allow for tailoring a desired heat output from each part of the heater.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

I claim:

1. An electric heating cable, comprising
a tubular, ferromagnetic outer conductor having an outer surface and an inner surface and a width therebetween, and further having a proximal end and a distal end, the outer conductor being electrically coupled at the proximal end to an alternating current (AC) source;
an inner conductor disposed within the outer conductor a minimum distance from the inner surface of the outer conductor, the inner conductor having a diameter that is smaller than an inner diameter of the outer conductor, and further having a proximal end electrically coupled to the AC source and a distal end electrically coupled to the distal end of the outer conductor, completing an electrical circuit; and
a mineral insulating layer filing the outer conductor around the inner conductor and offsetting the inner conductor at least the minimum distance from the inner surface of the outer conductor, such that an electric current flows without arcing through the electrical circuit within a band of the outer conductor that extends a predetermined depth from the inner surface into the outer conductor, the depth being less than the width of the outer conductor such that the outer surface of the outer conductor is non-conductive of the electric current.

2. The electric heating cable of claim 1, further comprising a layer of corrosion resistant alloy cladding the outer conductor at the outer surface thereof.

3. The electric heating cable of claim 1, wherein the width of the outer conductor is at least three times the depth of the band measured at room temperature.

4. The electric heating cable of claim 3, wherein the width of the outer conductor is selected based on a predetermined frequency at which the electric current is to be alternated.

5. The electric heating cable of claim 1, wherein the outer conductor comprises a ferromagnetic material exhibiting high creep strength.

6. The electric heating cable of claim 5, wherein the ferromagnetic material is 1% carbon steel.

7. The electric heating cable of claim 1, wherein the inner conductor is ferromagnetic.

8. The electric heating cable of claim 1, wherein the inner conductor is coaxial with the outer conductor.

9. The electric heating cable of claim 1, wherein the inner conductor is not coaxial with the outer conductor.

10. The electric heating cable of claim 1, wherein the mineral insulating layer comprises an electrically insulating ceramic having high thermal conductivity.

11. The electric heating cable of claim 10, wherein the ceramic is magnesium oxide.

12. The electric heating cable of claim 10, wherein the ceramic is a compacted powder.

13. The electric heating cable of claim 12, wherein the ceramic is about 80% compacted within the outer conductor.

14. The electric heating cable of claim 10, wherein the mineral insulating layer further comprises one or more insulating inert gasses.

15. The electric heating cable of claim 1, wherein the mineral insulating layer comprises a compacted powder having a compaction of about 80%.

16. The electric heating cable of claim 1, wherein the mineral insulating layer is configured to prevent arcing between the outer conductor and the inner conductor when the electric current is between about 10 amps and about 500 amps.

17. The electric heating cable of claim 1, wherein the mineral insulating layer is configured to prevent arcing between the outer conductor and the inner conductor at an AC voltage of about 2500 volts.

18. The electric heating cable of claim 1, comprising a first part having a first resistance and a second part having a second resistance lower than the first resistance.

19. The electric heating cable of claim 18, wherein the second part comprises one or more conductive materials coupled with one or both of the outer conductor and the inner conductor to create the second resistance.

20. The electric heating cable of claim 18, wherein:
in the first part of the electric heating cable, the outer conductor, inner conductor, and mineral insulating layer together form a first geometry that creates the first resistance; and
in the second part of the electric heating cable, the outer conductor, inner conductor, and mineral insulating layer together form a second geometry that is different from the first geometry and creates the second resistance.
